(19) United States
(12) Patent Application Publication
(10) Pub. No.: US 2026/0366602 A1
(43) Pub. Date: Nov. 19, 2026

(54) LINEAR DRIVE MECHANISM

(71) Applicant: AAC Acoustic Technologies (Shanghai) Co., Ltd., Shanghai (CN)

(72) Inventors: Kaiqi Xu, Shanghai (CN); Liang Jiang, Shanghai (CN)

(21) Appl. No.: 19/305,825

(22) Filed: Aug. 21, 2025

Related U.S. Application Data
(63) Continuation of application No. PCT/CN2025/094798, filed on May 14, 2025.

(51) Int. Cl. F16H 25/20; H02K 7/06; H02K 7/08; H02K 11/33

(52) U.S. Cl. CPC F16H 25/2015; H02K 7/06; H02K 7/08; H02K 11/33; F16H 2025/2031; F16H 2025/2075; H02K 2211/03

(57) ABSTRACT

The present disclosure discloses a linear drive mechanism including a housing, a slide sleeve detachably fixed to the housing, a rotor rotatably connected to the housing, a stator, and an outstretched shaft including a first end extended into a transmission connection hole of the rotor to be movably connected to the rotor and a second end located outside the housing, glidingly connected to the slide sleeve. The stator is electrically activated to drive the rotor to rotate so that the outstretched shaft moves along a first direction. The linear drive mechanism in the present disclosure has more simple structure and higher reliability.

### FIELD OF THE PRESENT DISCLOSURE

The present disclosure relates to linear drive technologies, especially relates to a linear drive mechanism.

### DESCRIPTION OF RELATED ART

Fingers of humanoid robot serve as a key component for executing orders and finishing actions, which is crucial for the flexibility, precision, and adaptability of the robot.

In related art, a drive mechanism commonly includes brush motor and multi-stage planetary reducer, which make its structure complex and increase the installation cost and maintenance difficulty. Therefore, said drive mechanism has low reliability.

Therefore, it is necessary to provide an improved linear drive mechanism to overcome the problems mentioned above.

### SUMMARY OF THE INVENTION

One object of the present disclosure is to provide a linear drive mechanism with more simple structure and higher reliability.

The linear drive mechanism includes a housing having a receiving space, including a first inner surface enclosed the receiving space; a slide sleeve detachably fixed to one end of the housing along a first direction, a rotor rotatably connected to the housing and configured to rotate around the first direction, including a transmission connection hole extending along the first direction; a stator fixed on the first inner surface and surrounding the rotor at an interval; and an outstretched shaft, including: a first end along the first direction extended into the transmission connection hole to be movably connected to the rotor; and a second end along the first direction located outside the housing, glidingly connected to the slide sleeve; wherein the stator is electrically activated to drive the rotor to rotate so that the outstretched shaft moves along the first direction.

As an improvement, the housing includes a second inner surface vertical to the first direction and jointly enclosed the receiving space with the first inner surface, and a first through hole penetrating thereon from the second inner surface along the first direction; the slide sleeve includes a main body portion including a first limit surface abutted to the second inner surface, and a first limit portion protruding from the first limit surface and embedded into the first through hole.

As an improvement, further including a plurality of fixation members surrounding the first limit portion, the plurality of fixation members comprises at least one pin and at least one screw; the housing further includes at least one pin hole penetrating thereon from the second inner surface along the first direction; the at least one pin is mounted on the slide sleeve and correspondingly installed within the at least one pin hole; the at least one screw extends through the housing and mounted on the slide sleeve.

As an improvement, further including a drive circuit board electrically connected to the stator and fixed on one end of the housing away from the outstretched shaft along the first direction.

As an improvement, further including a sense magnet and a rotary encoder opposite to each other along the first direction; the sense magnet is fixed on one end of the rotor away from the outstretched shaft along the first direction, and the rotary encoder is fixed on the drive circuit board.

As an improvement, further including a first bearing and a second bearing; the rotor includes hollow shaft with the transmission connection hole, and a drive magnet sleeved on the hollow shaft along its circumferential direction; the hollow shaft comprises a third end rotatably connected to the housing through the first bearing, and a fourth end rotatably connected to the housing through the second bearing.

As an improvement, the rotor further includes a lock nut sleeved on the third end of the hollow shaft via threaded connection so as to form a first annular slot extended around the first direction; the housing further includes a second annular slot formed on the first inner surface and extended around the first direction; the first bearing is embedded between the first annular slot and the second annular slot.

As an improvement, the second bearing is located between an outer surface of the hollow shaft and the first inner surface of the housing; the sense magnet is fixed inside the hollow shaft.

As an improvement, the housing further includes a second limit portion extended into the hollow shaft and coaxially arranged with the hollow shaft; the second bearing is sandwiched between an inner surface of the hollow shaft and an outer surface of the second limit portion; the drive circuit board is mounted on the second limit portion.

As an improvement, the sense magnet is sleeved on an outer surface of the hollow shaft.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a linear drive mechanism in accordance with an exemplary embodiment of the present disclosure.

FIG. 2 is another isometric view of the linear drive mechanism in FIG. 1.

FIG. 3 is a front view of the linear drive mechanism in FIG. 1.

FIG. 4 is a top view of the linear drive mechanism in FIG. 1.

FIG. 5 is a cross-sectional view of the linear drive mechanism taken along line A-A in FIG. 3.

FIG. 6 is an exploded view of the linear drive mechanism in FIG. 1.

FIG. 7 is another exploded view of the linear drive mechanism in FIG. 1.

FIG. 8 is another isometric view of the linear drive mechanism in FIG. 1.

FIG. 9 is another isometric view of the linear drive mechanism in FIG. 1.

FIG. 10 is a front view of the linear drive mechanism in FIG. 8.

FIG. 11 is a top view of the linear drive mechanism in FIG. 8.

FIG. 12 is a cross-sectional view of the linear drive mechanism taken along line B-B in FIG. 10.

FIG. 13 is an exploded view of the linear drive mechanism in FIG. 8.

FIG. 14 is another exploded view of the linear drive mechanism in FIG. 8.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

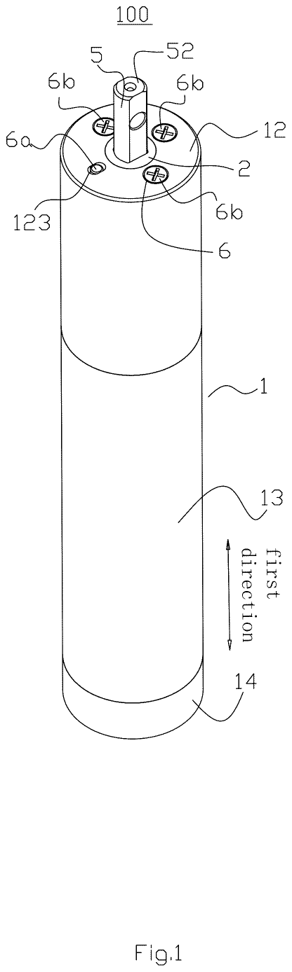

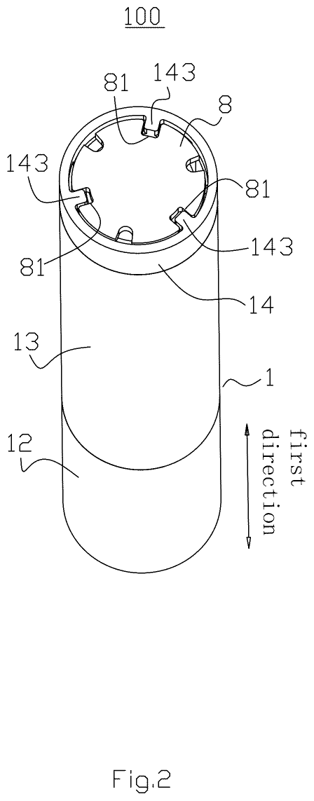

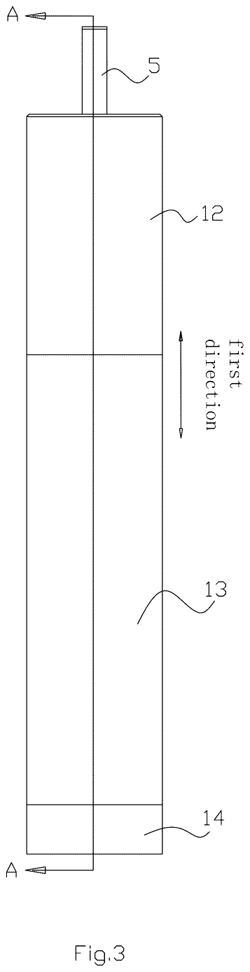

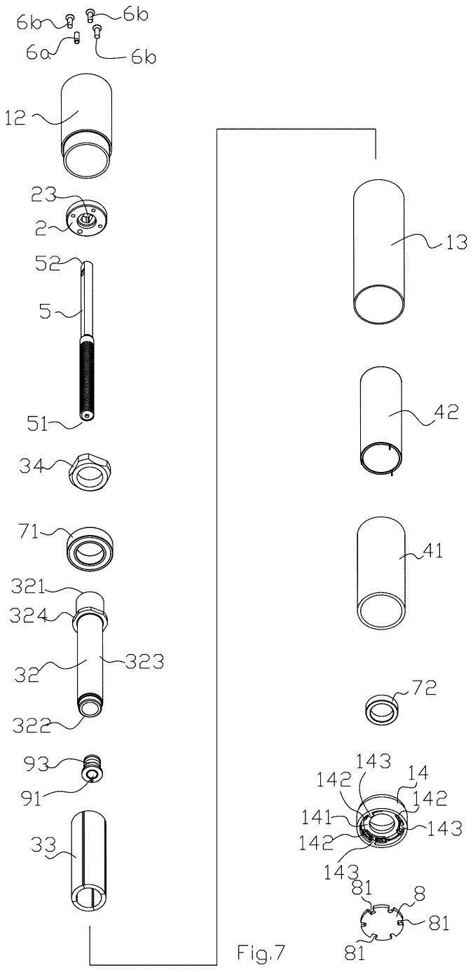

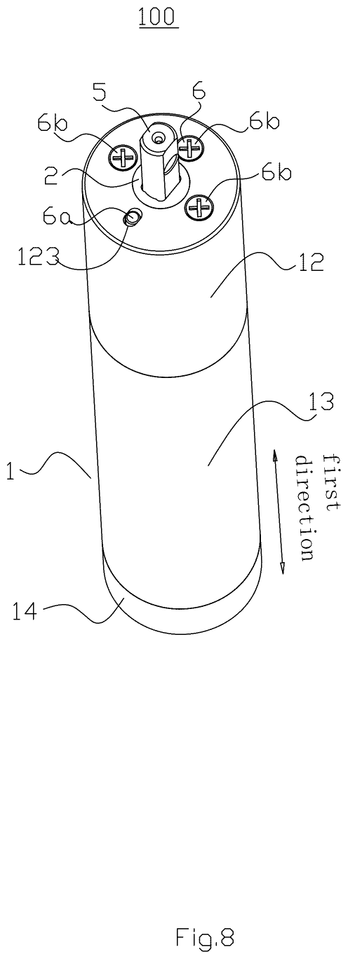

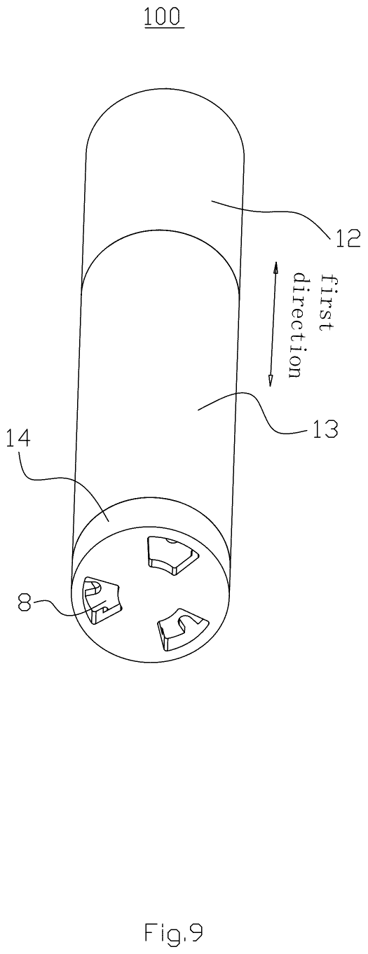

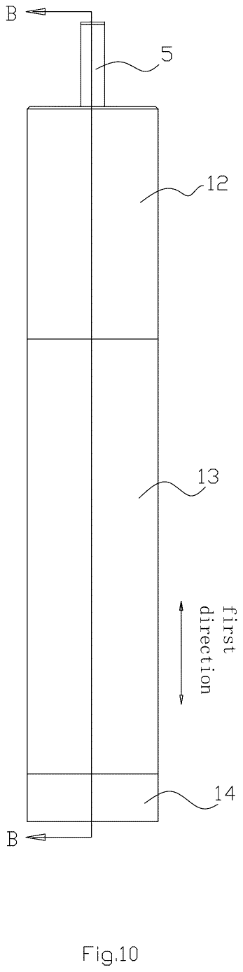

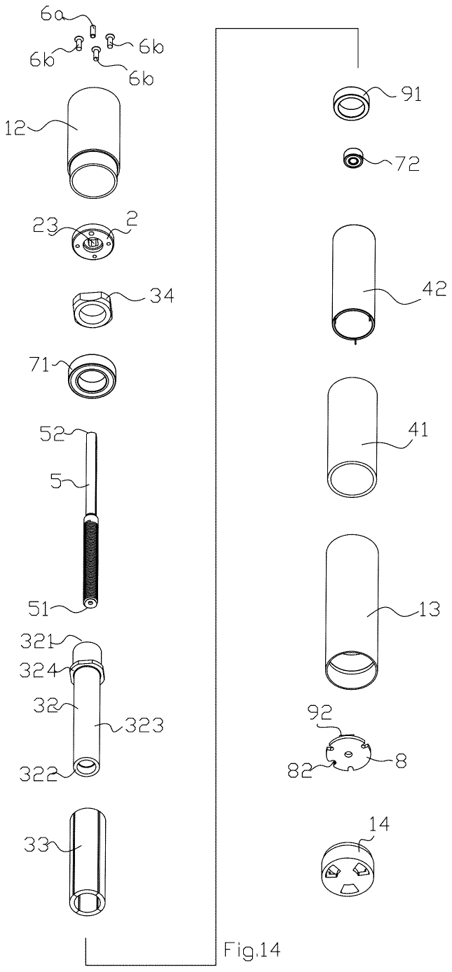

Please refer to FIGS. 1-14 together, a linear drive mechanism 100 provided by an exemplary embodiment of the present disclosure includes a housing 1 having a receiving space 11, a slide sleeve 2, a rotor 3, a stator 4, and an outstretched shaft 5 all received in the receiving space 110. In one embodiment, the linear drive mechanism 100 is in a cylindrical shape.

Specifically, the housing 1 includes a first inner surface 131 and a second inner surface 121 jointly enclosed the receiving space 11. The slide sleeve 2 is detachably fixed to one end of the housing 1 along a first direction. It can be understood that the first direction is an axis direction of the outstretched shaft 5. The slide sleeve 2 includes a guide hole 23 penetrating thereon along the first direction. The rotor 3 is rotatably connected to the housing 1 and configured to rotate around the first direction. Besides, the rotor includes a transmission connection hole 31 extending along the first direction. The stator 4 is fixed on the first inner surface 131 and surrounds the rotor 3 at an interval. The outstretched shaft 5 includes a first end 51 and a second end 52 along the first direction. The first end 51 extends into the transmission connection hole 31 to be movably connected to the rotor 3, and the second end 52 is located outside the housing 1 and glidingly connected to the slide sleeve 2 through the guide hole 23. And, the stator 4 is electrically activated to drive the rotor 3 to rotate so that the outstretched shaft 5 moves along the first direction.

In one embodiment, the rotation of the rotor 3 is transformed as linear movement of the outstretched shaft 5 through the slide sleeve 2. Therefore, the outstretched shaft 5 moves linearly along the first direction driven by the rotation of rotor 3 directly, thus simplifying the structure of the linear drive mechanism 100 and improving transmission efficiency and reliability of the linear drive mechanism 100. Besides, the detachable connection between the slide sleeve 2 and the housing 1 effectively avoids the friction between the housing 1 and the outstretched shaft 5, thus reducing the abrasion of the housing 1. The slide sleeve 2 which is worn after prolong use rather than the housing 1 could be replaced, therefore reducing the cost of the linear drive mechanism 100 and extending its service life.

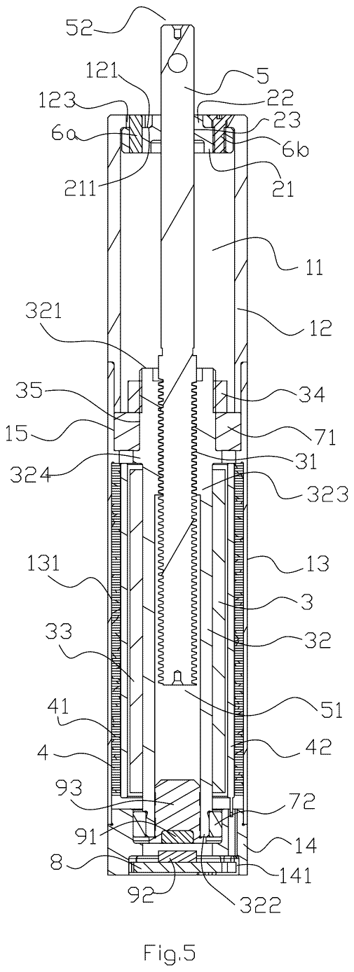

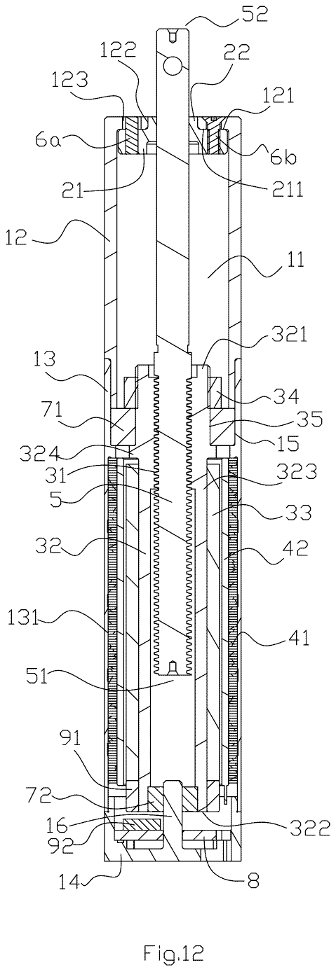

Referring to FIG. 5 and FIG. 12, the second inner surface 121 is vertical to the first direction. The housing 1 further includes a first through hole 122 penetrating thereon from the second inner surface 121 along the first direction. And, the slide sleeve 2 includes a main body portion 21 having a first limit surface 211 abutted to the second inner surface 121, and a first limit portion 22 protruding from the first limit surface 211. The first limit portion 22 is embedded into the first through hole 122. In this manner, the slide sleeve 2 could be installed onto the housing 1 more precisely and quickly, thus reducing the assembly deviation and improving assembly precision efficiency. Furthermore, the slide sleeve 2 would not deviate along the first direction when the outstretched shaft 5 moves, therefore increasing the impact resistance and service life of the slide sleeve 2.

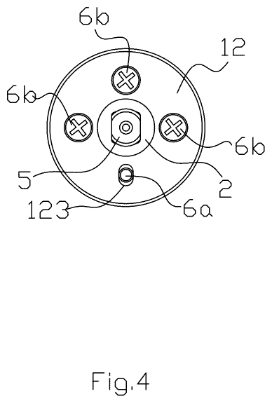

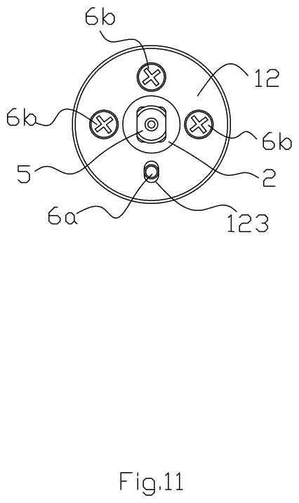

Moreover, the linear drive mechanism 100 further includes a plurality of fixation members 6 surrounding the first limit portion 22. The plurality of fixation members 6 includes at least one pin 6a and at least one screw 6b. The housing 1 further includes at least one pin hole 123 penetrating thereon from the second inner surface 121 along the first direction. The at least one pin 6a is mounted on the slide sleeve 2 and correspondingly installed within the at least one pin hole 123. The at least one screw 6b extends through the housing 1 and mounted on the slide sleeve 2. In one embodiment, the pin 6a and the slide sleeve 2 are integrally molded or interference fitted. Referring to FIG. 4 and FIG. 11, each of the at least one pin hole 123 is elliptical so as to reduce the assembly difficulty between the housing 1 and the slide sleeve 2.

in one embodiment, the number of the fixation member 6 is four. The four fixation members 6 are arranged at average intervals, thus improving the stability of the whole structure. And, the fixation member 6 includes one pin 6a and three screws 6b.

As shown in FIGS. 5-7 and FIGS. 12-14, the stator 4 includes a hollow iron core 41 and a winding 42 attached to an inner surface of the iron core 41. It can be understood that the winding 42 is spaced apart from the rotor 3. In one embodiment, the winging 42 is three-phase winding, and the iron core 41 is stacked by a plurality of silicon steel sheets.

To be specific, the rotor 3 includes a hollow shaft 32 with the transmission connection hole 31, and a drive magnet 33 sleeved on the hollow shaft 32 along its circumferential direction. The linear drive mechanism 100 further includes a first bearing 71 and a second bearing 72. The hollow shaft 32 includes a third end 321 rotatably connected to the housing 1 through the first bearing 71, and a fourth end 322 rotatably connected to the housing 1 through the second bearing 72.

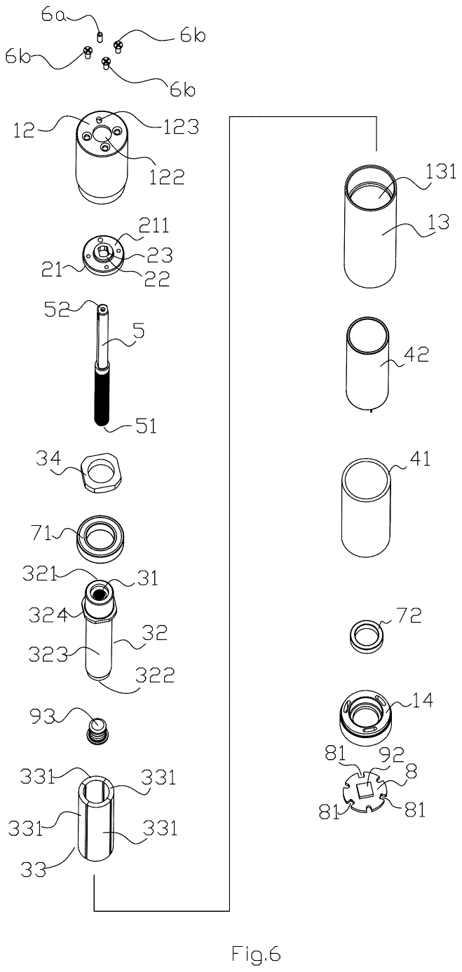

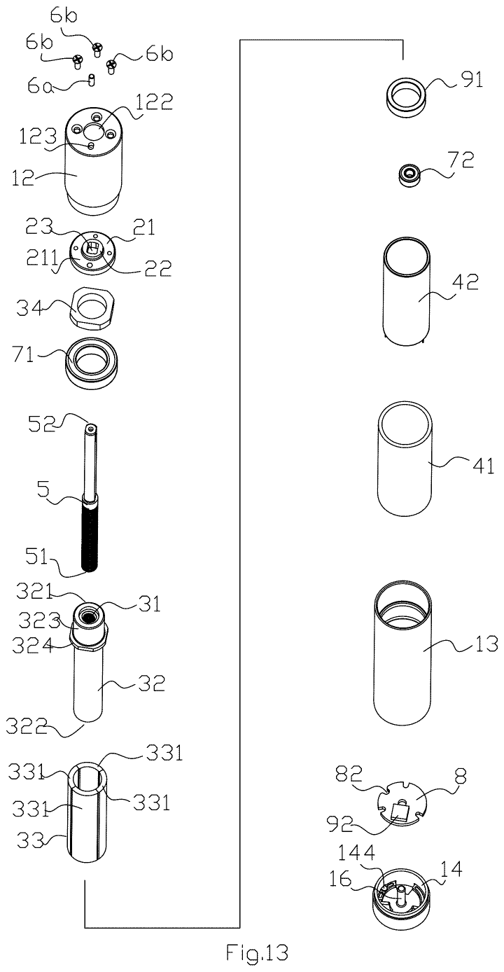

In one embodiment, as shown in FIG. 6 and FIG. 13, the drive magnet 33 is formed by four magnet portions 331. The four magnet portions 331 are configured to enclose a hollow annular structure sleeved on the hollow shaft 32.

Furthermore, as shown in FIGS. 5-7 and FIGS. 12-14, the rotor 3 further includes a lock nut 34 sleeved on the third end 321 of the hollow shaft 32 via threaded connection so as to form a first annular slot 35 extended around the first direction. The housing further includes a second annular slot 15 formed on the first inner surface 131 and extended around the first direction. The first bearing 71 is embedded between the first annular slot 35 and the second annular slot 15. It can be understood that the first bearing 71 is annular including an inner edge embedded into the first annular slot 35 and an outer edge embedded into the second annular slot 15. Thus, the threaded connection between the lock nut 34 and the hollow shaft 32 contributes to disassemble the first bearing 71, thus reducing the assemble difficulty.

Moreover, the hollow shaft 32 includes a shaft body 323 and a flange 324 protruding from the shaft body 323. The firs bearing 71 is sleeved on the shaft body 323. And, the first bearing 71 is sandwiched between the flange 324 and the lock nut 34 along the first direction. Thus, the first annular slot 35 is jointly enclosed by the lock nut 34, the shaft body 323 and the flange 324.

As shown in FIG. 5 and FIG. 12, the housing 1 includes a first shell 12 and a second shell 13 jointly forming the second annular slot 15. The slide sleeve 2 is mounted on the first shell 12. Thus, the outer edge of the first bearing 71 is limited between the first shell 12 and the second shell 13. Besides, the housing 1 further includes a third shell 14 inserted into an end of the second shell 13 away from the first shell 12 along the first direction. Additionally, the linear drive mechanism 100 further includes a drive circuit board 8 electrically connected to the winding 42 of the stator 4 and fixed on the third shell 14. By mounting the drive circuit board 8 on the third shell 14, the structure of the linear drive mechanism 100 is more compact. The first shell 12, the second shell 13 and the third shell 14 could be assembled by welding or glue.

As shown in FIGS. 5-7 and FIGS. 12-14, the linear drive mechanism 100 further includes a sense magnet 91 and a rotary encoder 92 opposite to each other along the first direction. The sense magnet 91 is fixed on to hollow shaft 32, and the rotary encoder 92 is fixed on the drive circuit board 8. The sense magnet 91 the rotary encoder 92 are provided to detect the rotation angle and speed of the rotor 3. In one embodiment, the rotary encoder 92 is angle position transducer.

Furthermore, the second bearing 72 is located between an outer surface of the hollow shaft 32 and the first inner surface 131 of the third shell 14 of the housing 1. The sense magnet 91 is fixed inside the hollow shaft 32 and located at the fourth end 322 of the hollow shaft 32. For easily installing the sense magnet 91, a magnet base 93 is provided in which the sense magnet 91 is embedded. In one embodiment, the second bearing 72 and the drive magnet 33 are arranged along the first direction, and the sense magnet 91 and the second bearing 72 are opposite to each other along a direction perpendicular with the first direction so that it is unnecessary to lengthen the rotor 3 thus ensuring the compact structure.

Furthermore, the third shell 14 includes a mounting hole 141 provided on an end away from the second shell 13, a location surface 142 and a first location protrusion 143 protruding from the location surface 142. The drive circuit board 8 is mounted inside the mounting hole 141 to partly seal the opening of the third shell 14 achieving dust prevention. Besides, the drive circuit board 8 includes a location slot 81 cooperated with the first location protrusion 143, thus avoiding the rotation of the drive circuit board 8 and ensuring its assembly accuracy and stability.

As shown in FIGS. 12-14, the housing 1 further includes a second limit portion 16 extended into the hollow shaft 32 and coaxially arranged with the hollow shaft 32. The second bearing 72 is sandwiched between an inner surface of the hollow shaft 32 and an outer surface of the second limit portion 16. The drive circuit board 8 is mounted on the second limit portion 16. Specifically, the third shell 14 includes a second location protrusion 144 on which the drive circuit board 8 is sleeved. In one embodiment, the sense magnet 91 is annular and then sleeved on the fourth end 322 of the hollow shaft 32.

In one embodiment, the outstretched shaft 5 is trapezoidal screw rod, and the transmission connection hole 31 is threaded hole engaged with the outstretched shaft 5.

The linear drive mechanism 100 in the present disclosure could be applied in finger or joint of the humanoid robot.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

1. A linear drive mechanism comprising:
a housing defining a receiving space, the housing comprising:
a first inner surface;
a second inner surface perpendicular to a first direction, the first inner surface and the second inner surface jointly defining the receiving space;
a first through hole opening at the second inner surface and extending through the housing along the first direction, and
at least one pin hole opening at the second inner surface and extending through the housing along the first direction;
a slide sleeve detachably fixed to one end of the housing along the first direction, the slide sleeve comprising:
a main body portion including a first limit surface abutting the second inner surface, and
a first limit portion protruding from the first limit surface and embedded in the first through hole;
a plurality of fixation members surrounding the first limit portion, the plurality of fixation members comprising at least one pin and at least one screw, wherein the at least one pin is mounted on the slide sleeve and correspondingly received within the at least one pin hole; and
wherein the at least one screw extends through the housing and is mounted on the slide sleeve;
a rotor rotatably connected to the housing and configured to rotate around the first direction, the rotor comprising a transmission connection hole extending along the first direction;
a stator fixed on the first inner surface and surrounding the rotor, wherein an interval is formed between the stator and the rotor; and
an outstretched shaft, comprising:
a first end along the first direction extended into the transmission connection hole to be movably connected to the rotor; and
a second end along the first direction located outside the housing, glidingly connected to the slide sleeve;
wherein the stator is configured, when energized, to drive the rotor to rotate, thereby causing outstretched shaft to move along the first direction.

2. (canceled)

3. (canceled)

4. The linear drive mechanism as described in claim 1, further comprising a drive circuit board electrically connected to the stator and fixed on one end of the housing away from the outstretched shaft along the first direction.

5. The linear drive mechanism as described in claim 4, further comprising a sense magnet and a rotary encoder opposite to each other along the first direction; the sense magnet is fixed on one end of the rotor away from the outstretched shaft along the first direction, and the rotary encoder is fixed on the drive circuit board.

6. The linear drive mechanism as described in claim 5, further comprising a first bearing and a second bearing, wherein the rotor comprises a hollow shaft defining the transmission connection hole, and a drive magnet sleeved on the hollow shaft along a circumferential direction of the hollow shaft; the hollow shaft comprises a third end rotatably connected to the housing through the first bearing, and a fourth end rotatably connected to the housing through the second bearing.

7. The linear drive mechanism as described in claim 6, wherein the rotor further comprises a lock nut sleeved on the third end of the hollow shaft via threaded connection so as to form a first annular slot extended around the first direction; the housing further comprises a second annular slot formed on the first inner surface and extended around the first direction; the first bearing is embedded between the first annular slot and the second annular slot.

8. The linear drive mechanism as described in claim 6, wherein the second bearing is located between an outer surface of the hollow shaft and the first inner surface of the housing; the sense magnet is fixed inside the hollow shaft.

9. The linear drive mechanism as described in claim 6, wherein the housing further comprises a second limit portion extended into the hollow shaft and coaxially arranged with the hollow shaft; the second bearing is sandwiched between an inner surface of the hollow shaft and an outer surface of the second limit portion; the drive circuit board is mounted on the second limit portion.

10. The linear drive mechanism as described in claim 9, wherein the sense magnet is sleeved on an outer surface of the hollow shaft.
